(19) United States
(12) Patent Application Publication
(10) Pub. No.: US 2025/0272599 A1
(43) Pub. Date: Aug. 28, 2025

(54) ON-SITE UPDATING OF MACHINE LEARNING MODELS AND MACHINE LEARNING MODELS INCORPORATING HARDWARE AND RUNTIME ATTRIBUTES

(71) Applicant: Xilinx, Inc., San Jose, CA (US)

(72) Inventors: Sumit Nagpal, Hyderabad (IN); Karthic P, Hyderabad (IN); Padmini Gopalakrishnan, Hyderabad (IN); Eishita Yadav, Hyderabad (IN); Srinivasan Dasasathyan, Hyderabad (IN); Shabnam Banu, Hyderabad (IN)

(73) Assignee: Xilinx, Inc., San Jose, CA (US)

(21) Appl. No.: 18/584,668

(22) Filed: Feb. 22, 2024

(51) Int. Cl. G06N 20/00

(52) U.S. Cl. CPC G06N 20/00

(57) ABSTRACT

Updating machine learning models with user data includes executing, by a data processing system, a container including a first machine learning (ML) model, training data for the first ML model, and a library of machine learning functions. The data processing system executes one or more of the machine learning functions of the library. The one or more of the machine learning functions are configured to build a second ML model trained, at least in part, on user training data and to compare accuracy of the first ML model with accuracy of the second ML model. An ML model also may be trained to predict compilation time for circuit designs using training data that includes circuit design features, hardware features of a data processing system, and runtime features from the data processing system.

### TECHNICAL FIELD

This disclosure relates to machine learning and, more particularly, building machine learning models.

### BACKGROUND

Machine learning (ML) is a branch of artificial intelligence and computer science that seeks to implement computer executable models capable of imitating the way in which humans learn. Often, an ML model is capable of continued learning to improve accuracy in the tasks performed by the ML model. In some cases, the ML model may continue to learn even after deployment into the field.

In general, an ML model is trained using a data set. A first portion of the data set referred to as “training data” is used to train the ML model. A second portion of data from the data set referred to as “test data” is used to test the ML model as trained. The test data is held out from the training data. That is, the test data is not used to train the ML model. Once the ML model is trained, the ML model may be tested using the testing data to determine a level of accuracy of the ML model.

In some cases, an ML model that is deployed to end users may exhibit lower than expected accuracy. For example, despite the ML model generating accurate results on the test data, when released into the field and used by end users, the ML model may generate results of lower-than-expected accuracy. That is, the accuracy of the ML model drops when run by end users on user data. This may arise in cases where the user's data differs from the training data. In many situations, because the user data is private and highly confidential, the users are unable or unwilling to share their data with the ML provider to improve the accuracy of the ML model. Further, there is no practical way for the ML model provider to approximate or replicate the user's data to improve performance of the ML model.

### SUMMARY

In one or more example implementations, a method includes executing, by a data processing system, a container including a first machine learning model, training data for the first machine learning model, and a library of machine learning functions. The method includes executing, by the data processing system, one or more of the machine learning functions of the library. The one or more of the machine learning functions are configured to build a second machine learning model trained, at least in part, on user training data and to compare accuracy of the first machine learning model with accuracy of the second machine learning model.

The foregoing and other implementations can each optionally include one or more of the following features, alone or in combination. Some example implementations include all the following features in combination.

In some aspects, the second machine learning model is trained on the training data and the user training data.

In some aspects, the second machine learning model is trained only on the user training data.

In some aspects, the container includes a plurality of different machine learning models of different types. The first machine learning model and the second machine learning model are of a same type. In that case, the comparing uses at least one metric selected based on the type of the first machine learning model.

In some aspects, the second machine learning model is built using incremental learning.

In some aspects, the second machine learning model is built using full machine learning.

In some aspects, the user training data includes features extracted from user circuit designs.

In some aspects, the training data includes hardware features.

In some aspects, the training data includes runtime features.

In one or more example implementations, a method of constructing a machine learning model includes generating training data. The training data is generated by extracting, using a data processing system, circuit design features from a plurality of circuit designs. The training data is generated by extracting hardware features of the data processing system used to perform an implementation flow on one or more of the plurality of circuit designs. The training data is generated by extracting runtime features from the data processing system while the data processing system performs the implementation flow. The method includes training the machine learning model to predict a compilation time for circuit designs based on the training data.

In some aspects, the ML model is implemented as a single component ML model.

In some aspects, the ML model is implemented as a multi-component ML model.

In some aspects, the runtime features are extracted by sampling runtime attributes of the data processing system.

In some aspects, the hardware features are static.

In some aspects, the runtime features are dynamic and/or change over time. For example, the runtime features are sampled during implementation of the design flow and change over time as sampled.

In one or more example implementations, a system includes one or more hardware processors configured (e.g., programmed) to execute operations as described within this disclosure.

In one or more example implementations, a computer program product includes one or more computer readable storage mediums having program instructions embodied therewith. The program instructions are executable by computer hardware, e.g., a hardware processor, to cause the computer hardware to initiate and/or execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example of an executable framework capable of generating updated machine learning (ML) models in accordance with the inventive arrangements described within this disclosure.

FIG. 2 illustrates an example method of operation for the framework of FIG. 1.

FIG. 3 illustrates an example of an executable framework capable of generating predictions relating to operation of circuit design implementation tools.

FIG. 4 illustrates an example of an executable framework capable of generating updated ML models as adapted for use with circuit design implementation tools.

FIG. 5 illustrates a list of example metrics that may be used to compare the accuracy of ML models.

FIG. 6 is an example method of training different ML models for use with circuit design implementation tools.

FIG. 7 illustrates an example architecture for an integrated circuit.

FIG. 8 illustrates an example implementation of a data processing system for use with the inventive arrangements described within this disclosure.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to machine learning and, more particularly, to building machine learning (ML) models. In accordance with the inventive arrangements, methods, systems, and computer program products are provided that are capable of updating ML models with user data. An ML model may be deployed into the field for use by a user (e.g., an end user). The user may generate a different version of the ML model based, at least in part, on the user's own data. The generation of the different version of the ML model may be performed on-site of the user premises using the user's computer equipment. The inventive arrangements provide a technical effect in that the ML model, as updated based on user data that is otherwise unavailable to the ML model provider to train the ML model, operates with greater accuracy than the original ML model particularly when run on other items of the user's data.

The inventive arrangements provide further technical effects that include generating the updated ML model while protecting both the user's data and the technology of the ML model provider. The ML model and related technology used to build the ML model, though accessible by the user to generate the updated version of the ML model, remains protected. The user, for example, does not have access to any source code of, or the ability to inspect, the ML model, the data that belongs to the ML model provider that is used to train the ML model, and/or optionally any program code used in the ML model update process and/or ML model comparison process. Further, the user maintains control and confidentiality of any user data that may be used in the ML model updating process. That is, user data is not shared with any other party, including the ML model provider, despite the use of such data in generating the updated version of the ML model. The user's data may remain entirely within the computer system controlled by the user, e.g., on-site for the user.

The inventive arrangements also include methods, systems, and computer program products for constructing an ML model that is capable of estimating the runtime of a computer system in processing certain types of data. As an example, the data may be a user circuit design. The ML model may be trained to utilize particular features extracted from the circuit design itself to generate a prediction of the runtime of computer-based implementation tools to perform an implementation flow, different phases of the implementation flow, or different operations on the user circuit design.

The inventive arrangements also include methods, systems, and computer program products for constructing an ML model that is capable of estimating runtime and/or usage of data processing system resources for performing a particular task such as processing a circuit design. The ML model may be trained on training data that includes features extracted from hardware attributes of the particular data processing system(s) used to generate the training data (e.g., the data processing systems that process circuit designs through various operations such as implementation flows). The training data also may include features extracted from runtime attributes. Runtime attributes, or runtime data, define the state of the hardware of the data processing system(s) while performing a particular task. For example, the runtime attributes may be obtained from the data processing system(s) while the data processing systems execute implementation flows, different phases of the implementation flow(s), and/or different operations on the user circuit design(s). The runtime attributes, for example, may reflect the load placed on certain components of the data processing system during the implementation flow and/or whether the data processing system is dedicated to executing an implementation flow or is not (e.g., is executing at least one other job concurrently with the implementation flow(s)). By including such attributes in training data for the ML models, the resulting ML models, as trained, achieve greater accuracy since the real-world operating environment of the data processing system(s) as used to process circuit designs is accounted for.

The inventive arrangements also include methods, systems, and computer program products for constructing a multi-component ML model. The multi-component ML model may include a plurality of ML models that operate in phases. For example, the multi-component model may utilize two or more ML models that operate serially with each ML model operating on a result obtained or generated by a prior ML model.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

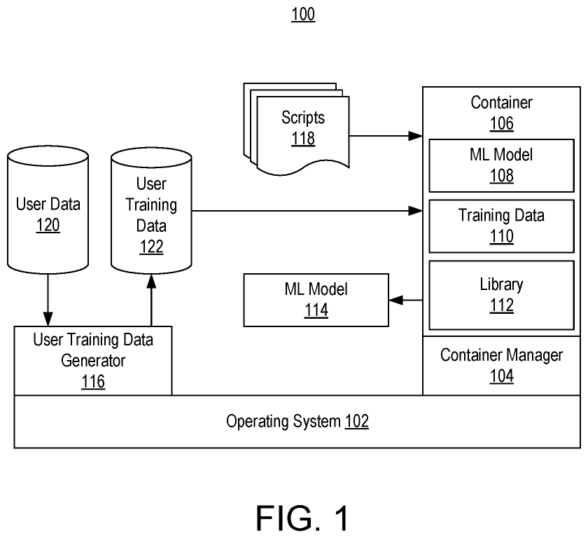

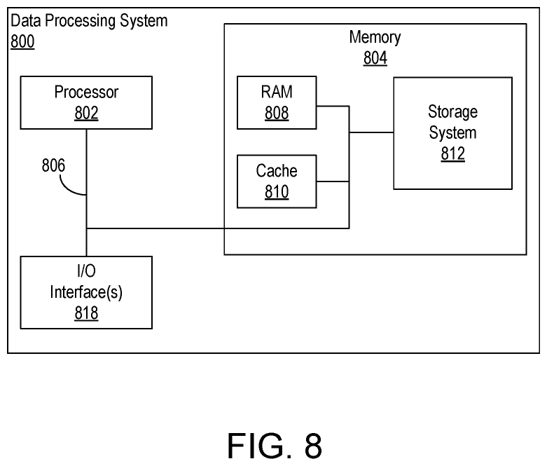

FIG. 1 illustrates an example of an executable framework capable of generating updated ML models in accordance with the inventive arrangements described within this disclosure. Framework 100 is executable by a data processing system, e.g., a computer, to perform the various operations described herein. A data processing system capable of executing framework 100 is described in connection with FIG. 8.

In an aspect, framework 100 is executed entirely within or by a user computing environment. The user computing environment may be implemented as one or more inter-connected data processing systems. The one or more data processing systems are owned and/or controlled by a user. In this regard, framework 100 may be referred to as an on-site system or equipment in that the framework executes on computer equipment on the user's site. The user may be a human being or an entity such as, for example, a company or other organization.

The inventive arrangements are operable with any of a variety of different types of data and/or applications to incorporate user (e.g., private or confidential) data into an existing ML model and/or create a new ML model. Within this disclosure, the term “user data” refers to data that is considered private or confidential by the user. In this regard, the user data is data that is not to be shared with other users. For example, the user data remains within the user computing environment. Within this disclosure, an ML model that is updated through training involving both training data 110 and user data 120, or a derivation thereof, or a newly created ML model generated through training involving only user data 120, or a derivation thereof, both are referred to as a “new ML model,” an “updated ML model,” or an “updated version of the/an ML model.”

In the example, framework 100 includes an operating system 102 and a container manager 104. Container manager 104 may be implemented as a container application or layer (e.g., a container engine or management application) that is configured to load, execute, administer, and/or manage containers. A container is a packaging of program code and data that includes the operating system (OS) libraries and dependencies required to run the program code. The package, as created, is a lightweight executable. The container is able to run or execute on any infrastructure provided a compatible or suitable container manager is installed on the infrastructure (e.g., data processing system).

A container does not include the entirety of an operating system as is the case with a virtual machine. That is, unlike a virtual machine, a container includes only program code (e.g., an application) and the operating system (OS) libraries and dependencies required to run the program code. As such, in general, a container is more portable and resource-efficient than a virtual machine. Typically, an application may be packaged in a container where the container includes the necessary software libraries for the application to execute in a user computing environment. Examples of container technologies that may be used with the inventive arrangements include, but are not limited to, DOCKER of Palo Alto, California, and KUBERNETES.

In the example, a container 106 has been deployed from an ML provider to a user data processing system (e.g., on-site and in the field). Container 106 is available for execution on and/or by the user data processing system. The provider of container 106 and user training data generator 116 may be the same entity in that the two objects are intended to operate cooperatively. More particularly, user training data generator 116 is configured to generate data that may be consumed by container 106 whether consumed as input to an ML model or an updated ML model or consumed to train a new ML model. Container 106 also is configured to generate updated ML models that may be used or invoked by user training data generator 116.

Container 106 includes an ML model 108, training data 110, and a library 112. In one or more examples, each of ML model 108 and training data 110 is included in container 106 in an encrypted form. One or more portions or all of library 112 also may be encrypted. Any components of container 106 that are encrypted are protected and are not exposed to users. While encrypted, such components may be invoked or executed in container 106 by a user.

For example, any program code and/or source code of ML model 108, training data 110, and/or library 112 may not be read or obtained by an end user. The user may only execute ML model 108 and/or program code of library 112. ML model 108 may be implemented and execute entirely within container 106 as a fully trained and executable ML model. Training data 110 is the training data on which ML model 108 has been trained. For example, training data 110 includes features extracted from data put together by the ML model provider, where the features are used to train ML model 108.

Library 112 is a library of program code. The program code of library 112 is configured to perform various machine learning functions. The program code may be provided from the ML model provider and/or from one or more third parties. The program code of library 112 may include one or more machine learning functions and/or one or more machine learning support functions. Such functions may include training or data cleaning/manipulation code. As an illustrative and non-limiting example, library 112 may include one or more C++ and/or Python packages. Library 112 may include an ML model library such as “scikit-learn” or other library, package, or third party program code. Library 112 also may include program code that implements training functions, program code in the form of scripts, or the like as may be provided from the ML model provider. Such program code, for example, may invoke one or more functions of third party libraries included in library 112.

For example, library 112 may include program code that is executable, or configured to, allow users to run ML model 108, generate updated versions of ML model 108 (e.g., ML model 114), and perform other operations as described herein including various types of ML model training and ML model comparisons. The comparisons may compare performance (e.g., accuracy) of ML model 108 with any updated versions thereof using one or more predetermined metrics. The various components illustrated as being within container 106, e.g., ML model 108 and library 112, when invoked or run, execute inside container 106. Training data 110 also remains within container 106 and as used by function(s) of library 112 remains within container 106 so as not to be exposed to users.

Framework 100 includes a user training data generator 116. Framework 100 and container 106 may include additional executable program code (not shown) for performing other operations described herein. In the example, user training data generator 116 may be implemented as an application and, as executed, is capable of operating on user data 120 to extract features therefrom and output or store the features as extracted as user training data 122. In general, user training data 122 is a type of user data that is generated by user training data generator 116 that is consumable by program code of container 106.

In some embodiments, framework 100 includes one or more scripts 118. Scripts 118 are executable and accessible by a user to invoke, execute, or otherwise access various program code and/or data of container 106.

The example of FIG. 1 is provided for purposes of illustration only. Other architectures and/or configurations may be implemented to provide similar or same functionality. In one or more other embodiments, user training data generator 116 may not be installed on a user system but rather included in a container. For example, user training data generator 116 may be included in container 106 or included in a different container that is provided with container 106. In either case, user training data generator 116 may execute within a container.

In one or more embodiments, scripts 118 may be provided within container 106. In that case, each script of scrips 118 may execute in container 106. For example, whether scripts 118 are included in container 106 or are stored and executed external to container 106, scripts 118 may be configured to invoke functions of user training data generator 116 and/or other functions and/or program code of container 106.

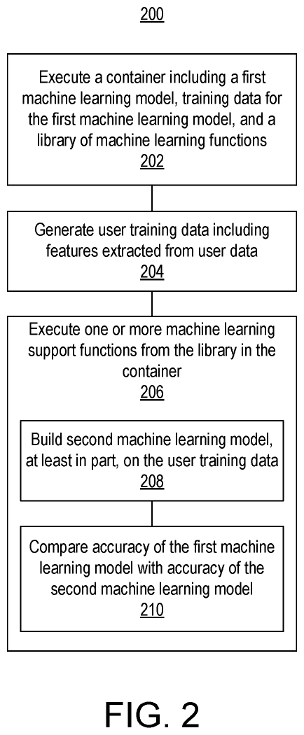

FIG. 2 illustrates an example method 200 of operation of framework 100 of FIG. 1. FIGS. 1 and 2, taken collectively, illustrate how an ML model may be updated and/or augmented with user data on-site. The updating/augmentation may be performed at the user site (e.g., using user equipment within the user computing environment) to avoid sharing any of user data 120 and/or user training data 122 with other parties including the ML model 108 provider.

Referring to FIGS. 1 and 2 collectively, in block 202, the data processing system executes container 106. For example, a user of the data processing system may provide an instruction that causes container 106 to be executed by container manager 104. As noted, container 106 includes ML model 108 (also referred to herein as the “first ML model”), training data 110, and library 112.

In one aspect, container 106 may be implemented based on a selected operating system such as Linux (e.g., a basic Ubuntu image). Container 106 encapsulates ML model 108, training data 110, and library 112. Container 106 ensures that program code, data, and all dependencies necessary for performing tasks such as training an ML model and/or comparing performance of the ML model as generated with one or more other ML models including ML model 108 are included in container 106 and isolated in container 106.

In block 204, user training data generator 116 generates user training data 122. User training data 122 includes features extracted from user data 120. In the example, user training data generator 116 is capable of operating on user data 120 to extract one or more features from each item of user data stored in user data 120 and store the features, as extracted, as user training data 122. For example, the user may request that user training data generator 116 implement a feature extraction process on user data 120. User training data generator 116 may process user data 120 and extract predetermined features therefrom. User training data 122, e.g., the features as extracted, may be stored in a designated directory as one or more data files. As an example, training data 122 may be stored as one or more Comma Separated Value (CSV) files, though other file formats may be used.

As discussed, user training data generator 116 may be installed on a user's data processing system and executed directly by the user's data processing system. In another example implementation, user training data generator 116 may be included in a container and executed within the container, e.g., as containerized. In either case, user training data generator 116 is capable of accessing user data 120 and generating user training data 122, which may be directly consumed by other program code of container 106. In one or more other examples, user training data generator 116 need only access any additional data, e.g., circuit designs, not shared with the ML model provider.

In block 206, one or more machine learning functions from library 112 in container 106 are executed. In one or more examples, the ML model provider may provide, as part of library 112, one or more one or more top level functions that may call other functions including third party machine learning libraries as discussed herein. In one or more other examples, program code of container 106 (e.g., machine learning and/or machine learning support functions) are executed by invoking one or more of the scripts 118. Scripts 118 may be pointed to, or configured to reference, user training data 122, e.g., the data files output from user training data generator 116.

In block 208, the one or more functions of library 112 that are executed build ML model 114. ML model 114 may be referred to herein as the “second ML model.” ML model 114 is trained, at least in part, on user training data 122. In one or more examples, ML model 114 is an updated version of ML model 108.

In one or more examples, ML model 108 and ML model 114 are the same type of ML model. For example, both ML models may be convolutional neural networks. In another example, both ML models may be decision trees. In another example, both ML models may be regressors. In another example, both ML models may be Random Forest models.

In one aspect, ML model 114 is trained using both training data 110 and user training data 122. In an example, where ML model 114 is trained using both training data 110 and user training data 122, ML model 114 is generated using incremental training. Incremental training is a technique that trains an existing ML model, e.g., ML model 108, using only additional training data which, in this case, is user training data 122, to generate an updated version of the ML model (ML model 114). Incremental training does not utilize the training data, e.g., training data 110, that was used to initially train ML model 108. Such is the case as incremental training adapts the originally trained model, e.g., ML model 108, which already represents training data 110.

In another aspect, where ML model 114 is trained using both training data 110 and user data 122, ML model 114 is trained using full training. Full training is a training process that trains an initially untrained ML model. With full training, ML model 108 is not considered. Rather, the function(s) of library 112 train an untrained version ML model 108 using both training data 110 and user training data 122.

In another aspect, where ML model 114 is trained using only user data 122, ML model 114 may be trained using full training.

In one or more examples, the particular type of ML model to be generated, e.g., one trained using both training data 110 and user training data 122 or one trained using only user training data 122 may be selected as a user specified option by way of the scripts 118. In addition, the particular type of training to be performed, e.g., incremental or full, may be selected as a user specified option by way of scripts 118. It should be appreciated that in cases where full training is an option, an untrained version of ML model 108 may be included in container 106 for such purposes.

In block 210, the one or more functions of library 112 that are executed are capable of comparing accuracy of ML model 108 with accuracy of any ML models that may be generated (e.g., shown as ML model 114). For example, library 112 includes function(s) that execute ML model 108 on selected test data to generate one or more metrics indicating accuracy of ML model 108. The function(s) also are capable of executing ML model 114 (which may be a plurality of ML models generated using any or each of the various techniques described herein) on the same selected test data to generate same metrics that indicate accuracy of ML model 114. The selected test data may include test data (not shown) included in container 106, only user specified test data, or both. In one or more examples, the test data to be used may be selected as a user specified option by way of scripts 118. The function(s) may output the metrics for each ML model so that the user may choose the more accurate ML model moving forward for their own needs. In one aspect, the function may output the comparison results and highlight or otherwise flag the ML model that is considered to be more accurate given the metrics compared.

In some examples, container 106 includes a plurality of ML models 108. Each of the ML models 108 included in container 106 may be a fully trained and executable ML model. In that case, training data 110 may include training data for each such ML model 108 included in container 106. Similarly, library 112 includes one or more functions that facilitate user access to run each of the plurality of ML models 108, generate different updated versions of each ML model of the plurality of ML models 108 as described above, and/or perform other operations as described herein including comparing performance (e.g., accuracy) of any of ML models 108 with any of ML models 114 that may be generated.

In one or more examples in which container 106 includes a plurality of different ML models, the plurality of ML models include models of different types (e.g., regressor, CNN, decision tree, Random Forest, etc.). It should be appreciated, however, that ML model 108 (the first ML model) and ML model 114 (the second ML model) are of the same type. Accordingly, the comparing of metrics uses at least one metric selected based on the type of the ML model 108. In other words, the particular metric(s) used to evaluate and compare accuracy of the ML models may be predetermined based on ML model type. That is, the metrics for comparison may be ML model specific. The function(s) of library 112 select the particular metric(s) to use based on the type of ML models being compared. The metrics may differ from one type of ML model type to another.

FIGS. 1 and 2 describe an approach in which an ML model provider may provide an ML model and mechanism for users to update (e.g., train or retrain) the ML model with the user's own private data without that data being shared with the ML model provider. Further, the use of container technology keeps the ML model provider's technology secure. For example, due to the containerization, the ML model provider's technology is only available to the user in the manner in which the ML model provider allows or intends.

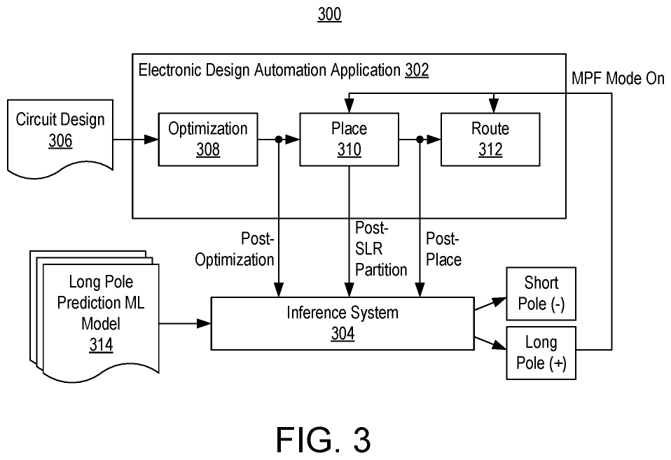

FIG. 3 illustrates an example of an executable framework 300 capable of generating predictions relating to operation of circuit design implementation tools. Framework 300 may be executed by a data processing system such as the example data processing system of FIG. 8.

In the example, framework 300 includes an Electronic Design Automation (EDA) application 302 and an inference system 304. Inference system 304 is configured to execute one or more ML models. For purposes of illustration, the ML models are configured to perform long pole design prediction (illustrated as long pole prediction ML models 314). As shown, a circuit design 306, e.g., a user circuit design, is provided to EDA application 302. EDA application 302 may perform a variety of functions such as optimization 308 (which may include synthesis), place 310, and route 312. Inference system 304, using one or more of long pole prediction ML models 314, is capable of generating a prediction as to the long pole of circuit design 306.

For purposes of illustration, circuit design 306 may be an emulation circuit design. Typically, an emulation circuit design is too large to fit in one programmable IC. Accordingly, the emulation circuit design is partitioned to into several sub-designs. Each sub-design is run on a different programmable IC. The compile time of the emulation circuit design is gated by the compile time of the longest running sub-design, which is called the “long pole.” The ability to accurately predict the long pole of the emulation circuit design allows EDA application 302 to reduce runtime by utilizing a greater number of hardware resources of the data processing system. For example, the EDA application 302 may use a larger number of cores or central processing units (CPUs) to reduce the compile time of the long pole.

As illustrated in the example of FIG. 3, different long pole prediction ML models 314 may be used at different stages of the implementation flow performed by EDA application 302. One long pole prediction ML model 314 may be used to predict which sub-design is a long pole post optimization. Another long pole prediction ML model 314 may be used to predict which sub-design is a long pole post Single-Logic Region (SLR) partitioning. An SLR is a region of logic which may include programmable logic. An example of an SLR is a die. Another long pole prediction ML model 314 may be used to predict which sub-design is a long pole post placement. After each of these implementation phases, more information about the implementation of circuit design 306 and its complexity is available, which improves the accuracy of the long pole prediction. A positive result indicates that a sub-design is considered the long pole.

Each long pole prediction ML model 314 uses features of circuit design 306 that are extracted and consumed as input by the particular long pole prediction ML model 314 that is selected. Based on the prediction by the selected long pole prediction ML model 314, different operational modes may be enabled for place 310 and/or route 312. For example, a multi-processor flow (MPF) mode may be enabled for place 310 and/or route 312 for a sub-design identified as the long pole to reduce the compile time of the overall circuit design 302. The MPF mode uses a larger number of cores or CPUs of the data processing system than when MPF mode is not used. For example, non-MPF mode may use a single core or single CPU. Using the MPF mode may reduce compile time of a circuit design by approximately 37% over the non-MPF mode, but will require approximately 3 times the computational resources of the non-MPF mode.

In the example of FIG. 3, the long pole prediction ML models 314 are trained using a set of circuit designs. These circuit designs may be developed by the same entity that provides ICs and/or EDA application 302. As such, ML models 314 may be built based on this training data. The training data may include predetermined or “in-house” circuit designs that are processed by EDA application 302 using the normal or non-MPF mode. The training data is labeled as to whether each circuit design or sub-design is a long pole. A threshold number “X” is chosen to label all designs taking more than “X” hours as long poles. In one example, based on this training data, long pole prediction ML models 314 may be built as Random Forest models. The features extracted and used for training data as well as the values of the features may vary based on the stage of the implementation flow at which the features are captured. Example features can include, but are not limited to, utilization of the target IC, fanout characteristics, run characteristics (e.g., compile runtime up to the stage at which the feature is extracted), partitioning information if available, and wirelength.

While the ML models may operate with a high degree of accuracy on test data available to the ML model provider, there are cases where the long pole prediction ML models 314, when run on user data, provide less accurate results. One possible reason is that the number of circuit designs used to generate training data 110 is limited as it becomes impractical to generate circuit designs that anticipate each user need and/or application. The user data (e.g., user circuit designs) may differ markedly from the circuit designs on which long pole prediction ML models 314 were trained.

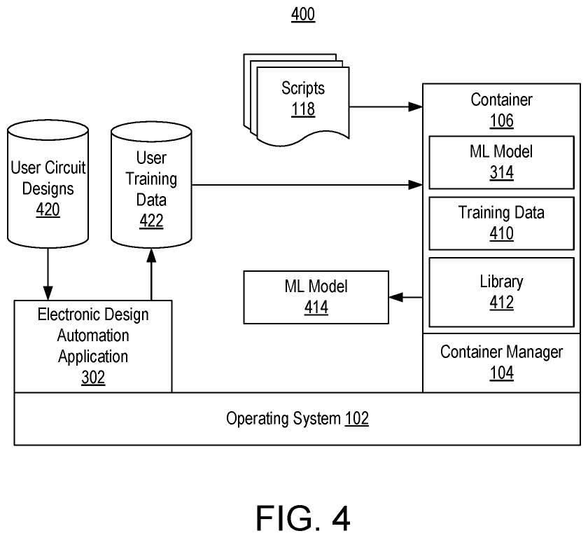

FIG. 4 illustrates an example of an executable framework 400 capable of generating updated ML models as adapted for use with circuit design implementation tools. In the example of FIG. 4, framework 100 of FIG. 1 has been adapted for use with EDA application 302. EDA application 302 is an example of the user training data generator 116 of FIG. 1. In the example of FIG. 4, for purposes of illustration, container 106 includes one or more of the long pole prediction ML models 314 (referred to herein also as ML models 314).

It should be appreciated that the ML models may be configured to perform any of a variety of different inference functions and/or predictions and that the use of circuit designs and long pole design prediction is for purposes of illustration only. The example of FIG. 4 illustrates how ML models 314 may be adapted or otherwise updated on-site to operate with greater accuracy on user data for a particular application that involves circuit designs.

In the example of FIG. 4, the user executes EDA application 302 on user circuit designs 420 to generate user training data 422. EDA application 302, for example, may be configured to extract the same features from user circuit designs 420 that are used by, or included in, training data 410. Appreciably, though the features may be the same, the features will have values specific to user circuit designs 420. These values may be significantly different from the values of the corresponding features in training data 410. The generation of user training data 422 enhances training data 410 by adding more circuit designs. In one or more aspects, users are not aware of what features are required to represent a circuit design. That is, the end user is unaware of the features extracted from user circuit designs 420 to generate user training data 422. EDA application 302 may include and respond to particular commands (e.g., TCL commands) that dump predetermined features, as extracted from user circuit designs 420, to a data file (e.g., user training data 422).

Using scripts 118, the user runs the modeling algorithms (e.g., functions) included in library 412 inside container 106. Scripts 118, for example, may point to user training data 422. Within container 106, one or more sub-scripts may be provided that, upon execution, label the circuit designs and run the training scripts and/or functions. The sub-script(s) further may explore the training space by fine-tuning. The function(s) from library 112 generate ML model 414 using any of the various techniques described herein. ML model 414 may be created as executable program code (e.g., object code). As noted, these may include full training or incremental training. Further, ML model 414 may be trained based on both user training data 422 and training data 410 or trained only on user training data 422. As noted, each of these options may be selected by a user as an option specified by way of scripts 118.

The code shown in Example 1 below illustrates an example call to a script of scripts 118 that the user may invoke. In Example 1, the term “design-dirs” is the location or area where additional data has been generated. The term “output_model_dir” is the directory where the updated ML model(s) are to be generated. These may be user specified. Options as note above such as full or incremental training and the particular training data to be used may be specified as flags or command line options.

### Example 1

### gen_models-output_model_dir <models_dir>—design_runs <design-dirs>

The code shown in Example 2 below illustrates an example call to a script of scripts 118 that informs EDA application 302 to use the updated ML model 414. In one or more embodiments, the example informs EDA application 302 to use updated ML model 414 in lieu of any other ML model. For example, EDA application 302 may use updated ML model 414 in lieu of a model that is included within EDA application 302 and/or in lieu of ML model 314. The example sets a parameter of EDA application 302 that tells EDA application 302 to use the updated ML models found in the directory “models-dir.” At the next normal launch of EDA application 302 (a launch of EDA application 302 without specialized parameters having been set), EDA application 302 will any ML models built into or included within EDA application 302.

### Example 2

### set-param flows.lpPredictor.newModels <models-dir>

As discussed, having generated an updated version of an ML model, that updated version may be compared against the original version of the ML model as provided in the container. Out of the user training data 122 and training data 110, some data (e.g., circuit designs) may be kept as test data for comparing accuracy of ML model 108 with accuracy of ML model 114. In some cases, the test data may include only a portion of user circuit designs 420 not used for purposes of training.

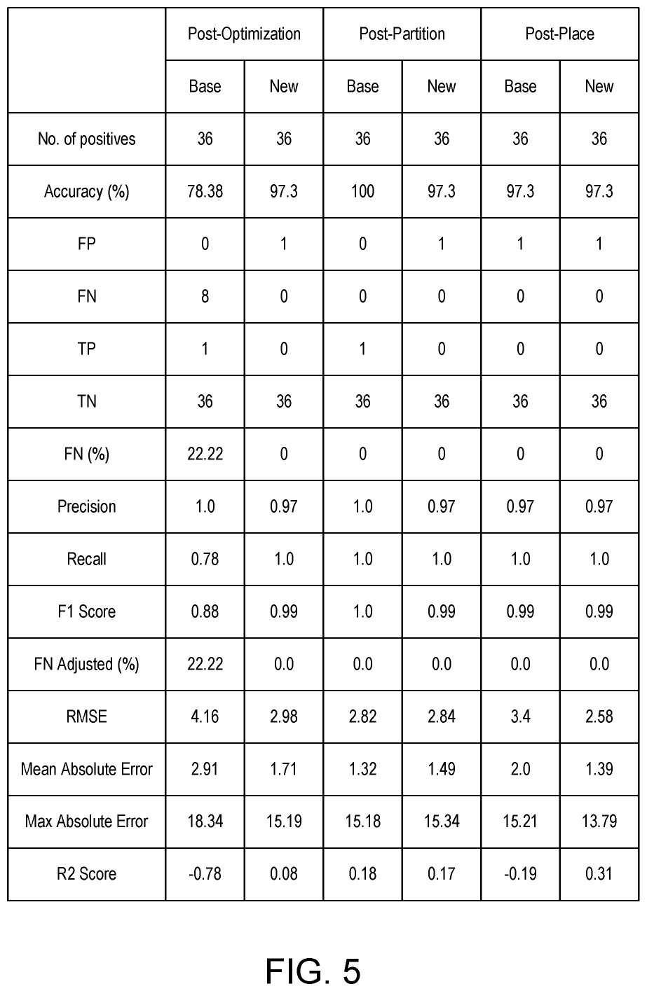

FIG. 5 illustrates a list of example metrics that may be used to compare the accuracy of ML models. In FIG. 5, the “Base” column refers to the original ML model (108, 408) packaged in the container, while “New” refers to the updated version of that ML model (114, 414). In the example, false positive is denoted as “FP,” false negative as “FN,” true positive as “TP,” and true negative as “TN.”

For purposes of illustration, consider an example in which the accuracies of ML models 408 packaged in container 106 for post optimization, post SLR partition, and post place, respectively, are 78.38, 100, and 97.3. Using the inventive arrangements and incremental training, the updated ML models 414 achieve accuracies for post optimization, post SLR partition, and post place, respectively, of 97.3, 97.3, and 97.3. The accuracies of ML model 108, 408 and of ML model 114, 414 illustrated in the example of FIG. 5, along with other metrics such as F1 and R2 scores, help the user to make a decision whether to use the new ML model or continue using the ML model from the container. The particular metrics used for evaluation may vary based on the type of the ML model. For some ML models, R2 may be used while for other ML models, accuracy may be preferred.

It should be appreciated that different metrics may be used for different circumstances and/or use cases. For example, in some situations accuracy may be used where accuracy is defined as Accuracy=(TP+TN)/(TP+TN+FP+FN). In general, accuracy provides a holistic view of ML model performance. In cases where the datasets used are unbalanced, the ML model may be ineffective despite having a high accuracy. In cases where correctness of positive predictions is of high importance, precision may be used where precision may be defined as Precision=TP/(TP+FP). In still other examples, the F1 Score may be used in cases where false negatives and false positives are considered important.

In one or more examples, the inventive arrangements are capable of estimating the compile time of EDA application 302 to process a given circuit design through an implementation flow. The inventive arrangements are also capable of predicting resource usage (e.g., memory usage) of the data processing system through such an implementation flow. An example implementation flow is shown in FIG. 3. In general, an implementation flow includes phases such as optimization (e.g., synthesis), place, and route. The implementation flow may include one or more additional optimization phases such as physical optimization. The compile time is the amount of time required for a computer-based implementation tool such as EDA application 302 to process a circuit design through a particular or predetermined implementation flow, a part of an implementation flow (e.g., one or more particular phases of the implementation flow or particular operations performed on a circuit design).

Implementation flows are often computationally intensive. Many modern circuit designs may have compilation times of 20 hours or more. The compile time may depend on a variety of different factors. These factors may include one or more or all of the implementation algorithms used, complexity (e.g., including size) of the circuit design, structure of the netlist, the specification of the data processing system on which the implementation tool will run or execute, and/or the load under which the data processing system is under during, e.g., while executing, the implementation flow. Dependence on these factors is non-linear, and heretofore, has not been well understood. Further complicating matters, the hardware attributes of the user data processing systems of users vary widely from one user to another. Moreover, the load under which different data processing systems, whether for a same user or across multiple, different users, also varies widely. Some data processing systems may be dedicated solely for performing circuit design related operations (e.g., implementation flow(s)). These data processing systems may be referred to as “dedicated” in that the data processing system executes no other job while executing an implementation flow or an operation of an implementation flow. A data processing system that executes one or more other tasks or jobs concurrently with executing an implementation flow or an operation of an implementation flow is referred to as a “shared” data processing system. All of these factors contribute to significant variation in compile times for the same circuit design from one user data processing system to another. Compile times, for example, may vary by up to approximately 10 hours owing to these considerations.

Obtaining an accurate estimate of compile time prior to initiation of the implementation flow on a circuit design allows the implementation tool(s) to better manage computing resources of the data processing system on which they execute and increase job throughput. These types of improvements are significant in a variety of different circuit design contexts including Application-Specific IC (ASIC) emulation systems where early prediction of long pole circuit designs may improve CPU and/or core usage by approximately 50% leading to approximately 100% job throughput improvement. Other benefits of accurate estimation of compile time may include compile time reduction via parameter selection and improved efficiency of load scheduling of compilation (e.g., implementation flow) jobs.

Accordingly, in one or more examples, an ML model is provided that is capable of generating compile time predictions for circuit designs with greater accuracy than other available ML models. The ML model is aware of the hardware attributes of the data processing system(s) that perform the implementation flow. Further, the ML model is aware of runtime attributes of the data processing system.

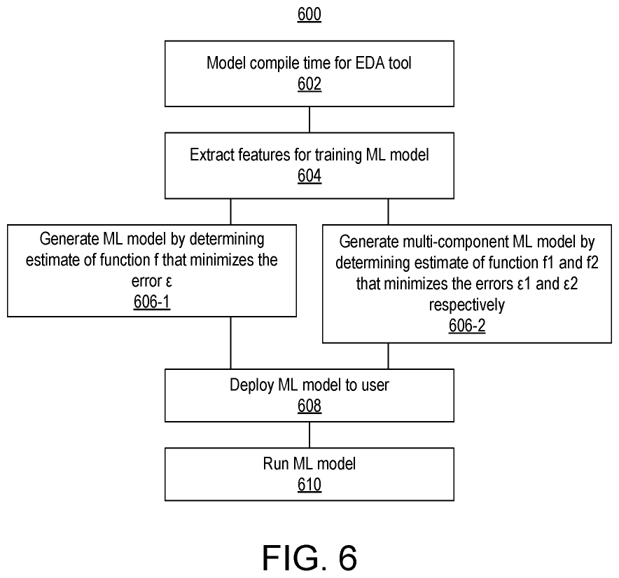

FIG. 6 is an example method 600 of training an ML model to estimate compile time for a circuit design through an implementation flow. Method 600 may be performed using a data processing system, an example of which is described in connection with FIG. 8.

In block 602, the compile time of a circuit design is modeled. An execution of an implementation flow for a circuit design is represented as Expression 1 below.

$$y = f ( {X}_{d} , {X}_{m} , {X}_{d , m} ) \qquad ( 1 )$$

The implementation flow, as represented by Expression 1, may be modeled as Expression 2 below.

$$y = \hat{f} ( {X}_{d} , {X}_{m} , {X}_{d , m} ) + ε \qquad ( 2 )$$

In Expressions 1 and 2:
y represents a vector with total compile times for n implementation flow executions. Within this disclosure, an implementation flow execution is also referred to as a “compilation run.”
X_{d}ϵ [symbol] ^{n×p}^{_{d}} represents p_{d} circuit design (e.g., netlist) features given a particular IC (e.g., a particular model of IC) in which the circuit design is to be implemented. The IC may be a programmable IC. Examples of X_{d} may include Configurable Logic Block (CLB) utilization % or the like for the n compilation runs. X_{d} may be referred to as “circuit design-IC” features.
Xₘϵ [symbol] ^{n×p}^{ₘ} represents pₘ hardware features and runtime features. Hardware features may be extracted from hardware attributes of the data processing system that will run the implementation flow. Example hardware features include static features such as the number of processor cores, amount of random-access memory (RAM), number of CPUs, etc. Runtime features may be extracted from runtime attributes.

Runtime attributes specify the load on the data processing system performing the implementation flow during execution of the implementation flow (e.g., the data processing system for which the hardware features are extracted). Runtime attributes (e.g., and runtime features) are dynamic in that runtime attributes of a given data processing system may only be measured during execution of the implementation flow and may change over time. Hardware attributes (e.g., and hardware features) of a given data processing system remain static.

The runtime features may be extracted by sampling runtime attributes of the data processing system. The runtime attributes may be sampled during the implementation flow. The runtime features, as extracted from the sampled runtime attributes change over time. In one or more example implementations, the runtime attributes may be sampled by an application (e.g., electronic design automation application 302, user training data generator 116, or other application). For example, one or more data collection threads may be executed during each phase of the implementation flow such as optimization, placement, routing, etc., where the application collects/samples the runtime attributes. The runtime attributes may include free memory, machine load, and the like. In one or more examples, at the end of each phase, the application is capable of averaging sampled runtime attributes and using the averaged values as features for training the ML model.
X_{d,m}ϵ [symbol] ^{n×p}^{_{d,m}} represents p_{d,m}, features such as the optimization wall time that depends on both design and data processing system resources.
ƒ is the underlying (unknown) function that maps X_{d}, Xₘ, X_{d,m} to the compilation time.
\hat{ƒ} is the best possible estimate of function ƒ that can be trained using machine learning with features X_{d}, Xₘ, X_{d,m} and label y.
ε represents a vector with errors in runtime estimation of all compilation runs.

A listing of the different features that may be included in each of X_{d}, Xₘ, and X_{d,m} is included at the end of the detailed description.

In block 604, features for training the ML model may be extracted. For example, circuit design features may be extracted from a data set of circuit designs. Design (IC) features may be extracted from a database of different ICs in which the circuit designs of the data set may be implemented. Hardware features may be extracted from hardware specifications listing the various components and/or querying, via software executing on the data processing systems to be used, the operating system and/or hardware components of the different data processing systems on which the circuit designs of the data set are to be processed through an implementation flow.

Runtime features may be obtained by sampling values for the respective runtime features periodically during execution of implementation flow(s) performed for the circuit designs of the data set across multiple different data processing systems. As an illustrative and non-limiting example, the values for the runtime features may be sampled per data processing system every N seconds (e.g., where N=30) during the running of an implementation flow on a circuit design from the data set. In one aspect, the values sampled for a given runtime feature may be averaged over multiple implementation flows for a given data processing system to obtain the final feature values used for training.

In another example implementation, referring to the different runtime features described herein, the values for the runtime features may be sampled periodically for each of the various phases of the implementation flow. For example, runtime features relating to load or available physical memory may be sampled periodically for each phase of the implementation flow (e.g., during optimization, during place, and during route). The sampled values for same runtime features, as extracted, may be averaged on a per phase basis.

In one or more examples, the ML model may be trained using training data that includes features extracted from compilation runs. As an example, the training data may include feature data extracted from approximately 10,000 compilation runs. The compilation runs may be executed on a plurality of different data processing systems with varying hardware attributes. For example, the training data set may include compilation runs run on approximately 450 different data processing systems that collectively have over 10 different CPU models. Further, the compilation runs may be performed with the different data processing systems operating under different loads.

Blocks 606-1 and 606-2 illustrate different types of ML models that may be generated as described in greater detail below. Continuing with block 606-1, in block 606-1, the system generates an ML model (e.g., a single component ML model) through supervised learning by determining \hat{ƒ} using available machine learning techniques that minimize ∥ε∥ or the Root Mean Squared Error (RMSE). Using the techniques described herein, the ML model, as trained, is capable of achieving an R2-score of 0.81 for runtime estimation for circuit designs not included in the training data and an RMSE of approximately 30 minutes for pre-placement stage circuit designs. The ML model, as built, is capable of scaling to unseen circuit designs across a wide range of different data processing systems. The ML model also may be extended to different implementation flows and/or to different programmable IC architectures (e.g., different models of ICs).

Certain types of CPUs, for example, may have multiple data points with compilation times that vary by more than one hour. This level of variance, particularly for a same circuit design being processed through an implementation flow, illustrates the importance of the data processing system and the data processing system load (runtime features) on actual compilation time.

In block 608, the ML model may be deployed to a user. For example, the ML model may be downloaded or otherwise installed or made available on a user data processing system. In one or more examples, the ML model may deployed in a container as illustrated in the examples of FIGS. 1 and/or 4. In another example, the ML model may be deployed without using container technology as illustrated in the example of FIG. 3. In block 610, the ML model may be run on the user data processing system to predict the compile time of one or more user circuit designs. As noted, particular implementation modes for EDA application 302 may be selectively enabled and/or disabled based on the predictions.

In one or more examples, user training data generator 116 (e.g., EDA application 302) may be configured to extract the features necessary for the ML models to be executed. That is, user training data generator 116 (e.g., EDA application 302) may extract the circuit design features, hardware features (e.g., from hardware attributes), runtime features (from runtime attributes), and/or any other data that is provided to the ML model as input to perform inference.

In one or more examples, to ensure that the resulting ML model performs well on compilation runs for circuit designs unseen during training, a data set may be split into training data and a test data with a ratio of 4:1. The ratio for splitting the data set ensures that the test data has unique circuit designs not available in the training data and that the compilation time distribution of the training data and the test data are similar. This approach further reduces data leakage and ensures representation of the entire compilation time range.

In one or more examples, the ML model is implemented as a decision tree. A decision tree is a binary tree data structure that is capable of capturing non-linear relationships between features and labels. In an aspect, Random Forest regressors may be used to reduce variance by training M decision trees in parallel and average the predictions generated by the M decision trees. In an aspect, XGBoost regressors may be used to reduce bias in predictions by sequentially training decision trees on errors from the previous decision tree. XGBoost is an optimized distributed gradient boosting library designed to provide efficient computation. In one or more examples, both Random Forest regressors and XGBoost regressors are used.

In one or more examples, hyperparameters of the ML model may be tuned using k-fold cross validation score(s). Hyperparameters are parameters of an ML model that do not depend on input data. In the case of tree-based ML models, hyperparameters include the parameters including, but not limited to, number of estimators and the maximum tree depth. The hyperparameters define the complexity of the ML model thereby affecting the bias and variance of the ML model. In an example, in using the k-fold cross validation score(s), the value of k may be set to 5 to avoid overfitting the hyperparameters for a given training data.

In one or more other example implementations, an improvement in estimating the compile time may be achieved using a differently structured ML model than described in connection with FIG. 6 above. In the example of FIG. 6, the ML model operated as a single component. By separating the ML model into multiple components (e.g., multiple different ML models) referred to as a multi-component ML model, improved performance in compile time estimation may be achieved. The multi-component ML model corresponds to performing block 606-2 of FIG. 6 in lieu of block 606-1. In the discussion below, it should be appreciated that each ML component is implemented as an ML model. Usage of the term component is intended only to differentiate the multi-component model from the ML model implemented as a single component.

Improved performance may be achieved by providing a first ML component that estimates runtime based on complexity of the circuit design and a second and different ML component that accounts for hardware attributes and runtime attributes. In generating the multi-component model, each ML component uses its own independent training data. The training data for the first ML component is mutually exclusive of the training data for the second ML component. The first ML component uses only features corresponding to X_{d}, for example, while the second ML component uses only features corresponding to Xₘ.

In training the first ML component, the training data set is formed only of X_{d} features extracted from compilation runs performed on data processing systems with same hardware attributes. For example, among other hardware features, the data processing systems have same CPU models. Further, the data processing systems are dedicated in that each is used only for performing the compilation runs with no other jobs being performed by the data processing systems while the compilation runs are performed. As such, the hardware attributes and the runtime attributes are the same for all compilation runs for which features are extracted to generate the training data set for the first ML component.

For the second ML component, the ratio of compile time on a shared data processing system to compile time on a dedicated data processing system for each circuit design is calculated. The ratio is referred to as the machine-runtime-factor (MRF) and is a function only of hardware attributes and runtime attributes.

In using the multi-component ML model, Expressions 1 and 2 above may be reformulated as Expressions 3 below.

$$y = {f}_{1} ( {X}_{d} ) \times {f}_{2} ( {X}_{m} ) \qquad ( 3 )$$

The estimation of compilation time for Expression 3 may be modeled as Expression 4 below.

$$y = ( {\hat{f}}_{1} ( {X}_{d} ) + {ε}_{1} ) \times ( {\hat{f}}_{2} ( {X}_{m} ) + {ε}_{2} ) \qquad ( 4 )$$

In Expressions 3 and 4, ƒ₁ and ƒ₂ represent the first ML component and the second ML component, respectively. Here, ƒ₁ and ƒ₂ are multiplied to provide a compile time estimate on any data processing system. \hat{ƒ}₁ and [symbol] represent the best estimates of ƒ₁ and ƒ₂, respectively, that may be achieved using available ML training algorithms that minimize ∥ε₁∥ and ∥ε₂∥ individually.

In an example, the first ML component may be implemented as a Random Forest regressor and trained using training data generated as described (e.g., having constant hardware features and constant runtime features). The first ML component taken alone and operating on pre-placed circuit designs unseen during training is capable of achieving an RMSE of 37 minutes and an R2 score of 0.79.

The second ML component is capable of generating a factor that is used to multiply the result of the first ML component. In one or more examples, the factor is in a range of 0.6 to 2.2 for compilation runs on a shared machine. A factor of 2.2 means that a compilation run for a particular circuit design on a shared data processing system took 220% of the compilation time that the compilation run took on a dedicated data processing system. Factors less than 1 may arise due to the data processing system having greater processing power (e.g., more processors) than the data processing systems used for training.

The second ML component may be implemented as an XGBoost model and may be trained on training data as described that includes only hardware features and runtime features. The second ML model is capable of achieving an RMSE of 0.08 and an R2-score of 0.89 for unseen and pre-placed circuit designs.

For purposes of illustration, the multi-component ML model may be implemented and deployed as generally described in connection with FIG. 6. In traversing FIG. 6, for the multi-component ML model, the path taken flows from block 602, to 604, to 606-2, to 608, and to 610.

In using both the first and second ML components together, the first ML component is capable of generating a prediction for a given, e.g., user, circuit design received as input. The second ML component is capable of generating the MRF given hardware features of the user's particular data processing system and runtime features of that data processing system. The runtime features collected as the user's data processing system processes the user's circuit design and/or other user circuit designs. The prediction from the first ML component is multiplied by the MRF to obtain a final prediction of compile time for the user circuit design used for the first ML component, where the final prediction depends on the user's particular data processing system and particular runtime features (e.g., load) of the user's data processing system. The resulting prediction may be made for any random, shared data processing system.

The multi-component ML model is capable of achieving an RMSE of 43 minutes and an R2 score of 0.85. In addition to providing improved accuracy over the single ML component approach (e.g., lower RMSE and higher R2 score), the multi-component ML model is capable of doing so using fewer features. That is, the number of features used to estimate of ƒ₁ and ƒ₂ (e.g., in Expression 4) is fewer than the number of features used in the model of FIG. 6 (e.g., Expression 2). The number of features used for of ƒ₁, for example, is ⅕ the number of features used for Expression 2. This provides a technical benefit of shorter runtimes for executing the multi-component ML model compared to the single component ML model of FIG. 6.

In one or more other examples, the multi-component ML model may use the same features as the single ML component approach. In that case, a subset of the features may be used for the first component while the remainder of the features are used for the second component.

In one or more example implementations, an ML model, whether a single component ML model or a multi-component ML model, as described in connection with FIG. 6 also may be deployed in a container and updated as discussed in connection with FIG. 4. For example, the ML model may be updated (e.g., trained) to generate an updated version of the ML model with features extracted from user circuit designs and/or hardware features determined from user data processing system(s). In the case of the multi-ML model, the first ML component, for example, may be updated using the user's circuit designs. The second ML component may be updated with the hardware features of the user's data processing system(s).

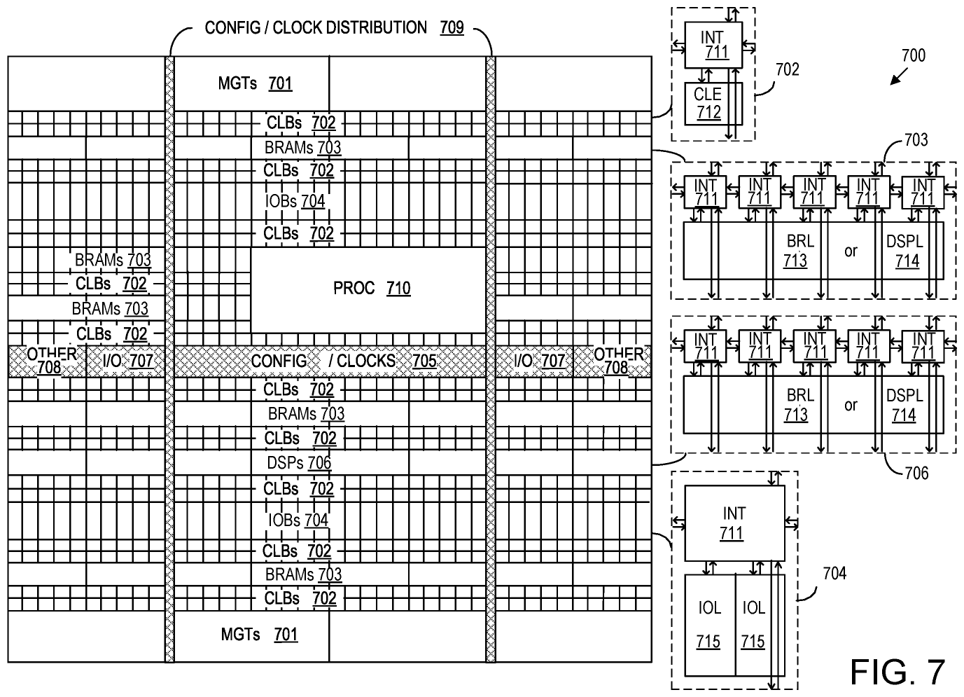

FIG. 7 illustrates an example architecture 700 for an IC. In one aspect, architecture 700 may be implemented within a programmable IC. For example, architecture 700 may be used to implement a field programmable gate array (FPGA). Architecture 700 may also be representative of a system-on-chip (SoC) type of IC. An example of an SoC is an IC that includes a processor that executes program code and includes one or more other circuits. The other circuits may be implemented as hardwired circuitry, programmable circuitry, and/or a combination thereof. The circuits may operate cooperatively with one another and/or with the processor.

As shown, architecture 700 includes several different types of programmable circuit, e.g., logic, blocks. For example, architecture 700 may include a large number of different programmable tiles including multi-gigabit transceivers (MGTs) 701, configurable logic blocks (CLBs) 702, random access memory blocks (BRAMs) 703, input/output blocks (IOBs) 704, configuration and clocking logic (CONFIG/CLOCKS) 705, digital signal processing blocks (DSPs) 706, specialized I/O blocks 707 (e.g., configuration ports and clock ports), and other programmable logic 708 such as digital clock managers, analog-to-digital converters, system monitoring logic, and so forth.

In some ICs, each programmable tile includes a programmable interconnect element (INT) 711 having standardized connections to and from a corresponding INT 711 in each adjacent tile. Therefore, INTs 711, taken together, implement the programmable interconnect structure for the illustrated architecture 700. Each INT 711 also includes the connections to and from the programmable logic element within the same tile, as shown by the examples included at the top of FIG. 7.

For example, a CLB 702 may include a configurable logic element (CLE) 712 that may be programmed to implement user logic plus a single INT 711. A BRAM 703 may include a BRAM logic element (BRL) 713 in addition to one or more INTs 711. Typically, the number of INTs 711 included in a tile depends on the height of the tile. As pictured, a BRAM tile has the same height as five CLBs, but other numbers (e.g., four) also may be used. A DSP tile 706 may include a DSP logic element (DSPL) 714 in addition to an appropriate number of INTs 711. An IOB 704 may include, for example, two instances of an I/O logic element (IOL) 715 in addition to one instance of an INT 711. The actual I/O pads connected to IOL 715 may not be confined to the area of IOL 715.

In the example pictured in FIG. 7, a columnar area near the center of the die, e.g., formed of regions 705, 707, and 708, may be used for configuration, clock, and other control logic. Horizontal areas 709 extending from this column may be used to distribute the clocks and configuration signals across the breadth of the programmable IC.

Some ICs utilizing the architecture 700 illustrated in FIG. 7 include additional logic blocks that disrupt the regular columnar structure making up a large part of the IC. The additional logic blocks may be programmable blocks and/or dedicated circuitry. For example, a processor block depicted as PROC 710 spans several columns of CLBs and BRAMs.

In one aspect, PROC 710 may be implemented as dedicated circuitry, e.g., as a hardwired processor, that is fabricated as part of the die that implements the programmable circuitry of the IC. PROC 710 may represent any of a variety of different processor types and/or systems ranging in complexity from an individual processor, e.g., a single core capable of executing program code, to an entire processor system having one or more cores, modules, co-processors, interfaces, or the like.

In another aspect, PROC 710 may be omitted from architecture 700 and replaced with one or more of the other varieties of the programmable blocks described. Further, such blocks may be utilized to form a “soft processor” in that the various blocks of programmable circuitry may be used to form a processor that can execute program code as is the case with PROC 710.

The phrase “programmable circuitry” refers to programmable circuit elements within an IC, e.g., the various programmable or configurable circuit blocks or tiles described herein, as well as the interconnect circuitry that selectively couples the various circuit blocks, tiles, and/or elements according to configuration data that is loaded into the IC. For example, circuit blocks shown in FIG. 7 that are external to PROC 710 such as CLBs 702 and BRAMs 703 are considered programmable circuitry of the IC.

In general, the functionality of programmable circuitry is not established until configuration data is loaded into the IC. A set of configuration bits may be used to program programmable circuitry of an IC such as an FPGA. The configuration bit(s) typically are referred to as a “configuration bitstream.” In general, programmable circuitry is not operational or functional without first loading a configuration bitstream into the IC. The configuration bitstream effectively implements a particular circuit design within the programmable circuitry. The circuit design specifies, for example, functional aspects of the programmable circuit blocks and physical connectivity among the various programmable circuit blocks.

Circuitry that is “hardwired” or “hardened,” i.e., not programmable, is manufactured as part of the IC. Unlike programmable circuitry, hardwired circuitry or circuit blocks are not implemented after the manufacture of the IC through the loading of a configuration bitstream. Hardwired circuitry is generally considered to have dedicated circuit blocks and interconnects, for example, that are functional without first loading a configuration bitstream into the IC, e.g., PROC 710.

In some instances, hardwired circuitry may have one or more operational modes that can be set or selected according to register settings or values stored in one or more memory elements within the IC. The operational modes may be set, for example, through the loading of a configuration bitstream into the IC. Despite this ability, hardwired circuitry is not considered programmable circuitry as the hardwired circuitry is operable and has a particular function when manufactured as part of the IC.

In the case of an SoC, the configuration bitstream may specify the circuitry that is to be implemented within the programmable circuitry and the program code that is to be executed by PROC 710 or a soft processor. In some cases, architecture 700 includes a dedicated configuration processor that loads the configuration bitstream to the appropriate configuration memory and/or processor memory. The dedicated configuration processor does not execute user-specified program code. In other cases, architecture 700 may utilize PROC 710 to receive the configuration bitstream, load the configuration bitstream into appropriate configuration memory, and/or extract program code for execution.

FIG. 7 is intended to illustrate an example architecture that may be used to implement an IC that includes programmable circuitry, e.g., a programmable fabric. For example, the number of logic blocks in a column, the relative width of the columns, the number and order of columns, the types of logic blocks included in the columns, the relative sizes of the logic blocks, and the interconnect/logic implementations included at the top of FIG. 7 are purely illustrative. In an actual IC, for example, more than one adjacent column of CLBs is typically included wherever the CLBs appear, to facilitate the efficient implementation of a user circuit design. The number of adjacent CLB columns, however, may vary with the overall size of the IC. Further, the size and/or positioning of blocks such as PROC 710 within the IC are for purposes of illustration only and are not intended as limitations.

FIG. 8 illustrates an example implementation of a data processing system 800. As defined herein, the term “data processing system” means one or more hardware systems configured to process data, each hardware system including at least one processor and memory, wherein the processor is programmed with computer-readable instructions that, upon execution, initiate operations. Data processing system 800 can include a processor 802, a memory 804, and a bus 806 that couples various system components including memory 804 to processor 802.

Processor 802 may be implemented as one or more processors. In an example, processor 802 is implemented as one or more CPUs. Processor 802 may be implemented as one or more circuits, e.g., hardware, capable of carrying out instructions contained in program code. The circuit may be an integrated circuit or embedded in an integrated circuit. Processor 802 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 806 represents one or more of any of a variety of communication bus structures. By way of example, and not limitation, bus 806 may be implemented as a Peripheral Component Interconnect Express (PCIe) bus. Data processing system 800 typically includes a variety of computer system readable media. Such media may include computer-readable volatile and non-volatile media and computer-readable removable and non-removable media.

Memory 804 can include computer-readable media in the form of volatile memory, such as RAM 808 and/or cache memory 810. Data processing system 800 also can include other removable/non-removable, volatile/non-volatile computer storage media. By way of example, storage system 812 can be provided for reading from and writing to a non-removable, non-volatile magnetic and/or solid-state media (not shown and typically called a “hard drive”), which may be included in storage system 812. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 806 by one or more data media interfaces. Memory 804 is an example of at least one computer program product.

Memory 804 is capable of storing computer-readable program instructions that are executable by processor 802. For example, the computer-readable program instructions can include an operating system, one or more application programs, other program code, and program data. For purposes of illustration, memory 804 may store the executable architectures illustrated FIGS. 1, 3, and/or 4.

Processor 802, in executing the computer-readable program instructions, is capable of performing the various operations described herein that are attributable to a computer. It should be appreciated that data items used, generated, and/or operated upon by data processing system 800 are functional data structures that impart functionality when employed by data processing system 800. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 800 may include one or more Input/Output (I/O) interfaces 818 communicatively linked to bus 806. I/O interface(s) 818 allow data processing system 800 to communicate with one or more external devices and/or communicate over one or more networks such as a local area network (LAN), a wide area network (WAN), and/or a public network (e.g., the Internet). Examples of I/O interfaces 818 may include, but are not limited to, network cards, modems, network adapters, hardware controllers, etc. Examples of external devices also may include devices that allow a user to interact with data processing system 800 (e.g., a display, a keyboard, and/or a pointing device) and/or other devices such as accelerator card.

Data processing system 800 is only one example implementation. Data processing system 800 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

As used herein, the term “cloud computing” refers to a computing model that facilitates convenient, on-demand network access to a shared pool of configurable computing resources such as networks, servers, storage, applications, ICs (e.g., programmable ICs) and/or services. These computing resources may be rapidly provisioned and released with minimal management effort or service provider interaction. Cloud computing promotes availability and may be characterized by on-demand self-service, broad network access, resource pooling, rapid elasticity, and measured service.

The example of FIG. 8 is not intended to suggest any limitation as to the scope of use or functionality of example implementations described herein. Data processing system 800 is an example of computer hardware that is capable of performing the various operations described within this disclosure. In this regard, data processing system 800 may include fewer components than shown or additional components not illustrated in FIG. 8 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

A system as described in connection with FIG. 8, for example, is capable of processing a circuit design having undergone the processing described herein for implementation within an IC having an architecture the same as or similar to that of FIG. 7. The system, for example, is capable of synthesizing, placing, and routing the circuit design. The system may generate appropriate bitstreams or configuration data so that the bitstreams may be loaded into the IC, thereby physically implementing the circuit design within the IC.

Below is an example listing of different features that may be used in the ML model trained in the example of FIG. 6 to estimate compile time for circuit designs. The features below include device (IC) features, circuit design features, hardware features, and runtime features (e.g., state of certain features as measured during one or more implementation flows).

### Device (IC) Features:

numBRAMCols
numConfigCols
numDSPCols
numlOCols
numPSCols
numSLRs
partName

### Circuit Design Features

clkRgnPerSLR_0
clkRgnPerSLR_1
clkRgnPerSLR_2
coresPerSocket
opt_allNetsWithFanout
opt_blockramUtilPerc
opt_carry8UtilPerc
opt_cmdOptions
opt_cmr
opt_controlSetGt8Perc
opt_controlSetsGtl6
opt_directive
opt_dspUtilPerc
opt_exitStatus
opt_7MuxUtilPerc
opt_8MuxUtilPerc
opt_FanoutGt500
opt_fanoutLt3Perc
opt_lut5UtilPerc
opt_lut6UtilPerc
opt_lutAsMemoryUtilPerc
opt_lutUtilPerc
opt_maxLatchFanout
opt_maxLutFanout
opt_registerAsLatchUtilPerc
opt_registerUtilPerc
opt_totalControlSets
physopt_cmdOptions
physopt_cmr
physopt_directive
physopt_exitStatus
physopt_tns
physopt_wns
place_allNetsWithFanout
place_avgGlobalCong
place_avgLongCong
place_avgMaxCongGlobalLongShort
place_avgMaxCongGlobalShort
place_avgShortCong
place_blockramUtilPerc
place_bramUtilPercHMPlacerSLRO
place_bramUtilPercHMPlacerSLR1
place_bramUtilPercHMPlacerSLR2
place_carry8UtilPerc
place_clbUtilPerc
place_cmdOptions
place_cmr
place_controlSetGt8Perc
place_controlSetsGt16
place_directive
place_dspUtilPerc
place_exitStatus
place_f7MuxUtilPerc
place_f8MuxUtilPerc
place_fanoutGt500
place_fanoutLt3Perc
place_ffUtilPecHMPlacerSLRO
place_ffUtilPecHMPlacerSLR1
place_ffUtilPecHMPlacerSLR2
place_lut5UtilPerc
place_lut6UtilPerc
place_lutAsMemoryUtilPerc
place_lutmUtilPecHMPlacerSLRO
place_lutmUtilPecHMPlacerSLR1
place_lutmUtilPecHMPlacerSLR2
place_lutUtilPecHMPlacerSLRO
place_lutUtilPecHMPlacerSLR1
place_lutUtilPecHMPlacerSLR2
place_lutUtilPerc
place_maxGlobalCong
place_maxLatchFanout
place_maxLongCong
place_maxLutFanout
place_maxShortCong
place_netsCrossingSLROSLR1
place_netsCrossingSLR1SLR2
place_pcoFinalWns
place_pcolnitialWns
place_pcoNumMoves
place_pinDensitySLROPerc
place_pinDensitySLR1 Perc
place_pinDensitySLR2Perc
place_registerAsLatchUtilPerc
place_registerUtilPerc
place_sllUtilPercSLROSLR1
place_sIIUtilPercSLR1SLR0
place_sIIUtilPercSLR1SLR2
place_sllUtilPercSLR2SLR1
place_totalClockNetsHMPlacer
place_totalControlSets
place_totalNetsCrossingSLRs
place_totalNetsCrossingSLRsHMPlacerPerc
place_totalNetWirelenHMPlacer
place_totalPinDensity
place_uniqueControlSetsUtilPerc
place_wireLenGainRatioGP2DP
place_wireLenGainRatiolnDP
place_wireLenGainRatiolnGP
place_wns
route_cmdOptions
route_cmr
route_directive
route_exitStatus
route_numGloballters
route_tns
route_wns
Hardware features
availPhysicalMemory
availSwapMemory
availVirtualMemory
bogoMips
cpuFreq
cpuMaxFreq
cpuMinFreq
cpuModelName
I1 DataCache
I1InstrCache
I2Cache
I3Cache
numCpus
numSockets
threadsPerCore
totalPhysicalMemory
totalSwapMemory
totalVirtualMemory

### Data Processing System Runtime Properties

opt_avgMachineLoad
opt_avgPhysicalMemory
opt_avgThreadSpawned
opt_avgTotalFreeMemory
opt_avgVirtualMemory
opt_ic
opt_maxThreadSpawned
opt_memoryGain
opt_peakMachineLoad
opt_peakMemory
opt_peakPhysicalMemory
opt_peakTotalFreeMemory
opt_peakVirtualMemory
opt_physicalMemory
opt_virtualMemory
physopt_avgMachineLoad
physopt_avgPhysicalMemory
physopt_avgThreadSpawned
physopt_avgTotalFreeMemory
physopt_avgVirtualMemory
physopt_ic
physopt_maxThreadSpawned
physopt_memoryGain
physopt_peakMachineLoad
physopt_peakMemory
physopt_peakPhysicalMemory
physopt_peakTotalFreeMemory
physopt_peakVirtualMemory
physopt_physicalMemory
physopt_virtualMemory
place_avgMachineLoad
place_avgPhysicalMemory
place_avgThreadSpawned
place_avgTotalFreeMemory
place_avgVirtualMemory
place_ic
place_maxThreadSpawned
place_memoryGain
place_peakMachineLoad
place_peakMemory
place_peakPhysicalMemory
place_peakTotalFreeMemory
place_peakVirtualMemory
place_physicalMemory
place_virtualMemory
route_ic
route_memoryGain
route_peakMemory
route_physicalMemory
route_virtualMemory

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, “execute” and “run” comprise a series of actions or events performed by the hardware processor in accordance with one or more machine-readable instructions. “Running” and “executing,” as defined herein refer to the active performing of actions or events by the hardware processor. The terms run, running, execute, and executing are used synonymously herein.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or media) having computer-readable program instructions thereon for causing a processor to carry out aspects of the inventive arrangements described herein. Within this disclosure, the term “program code” is used interchangeably with the term “program instructions.” Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages.

Computer-readable program instructions may include state-setting data. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer-readable program instructions by utilizing state information of the computer-readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer-readable program instructions, e.g., program code.

These computer-readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the operations specified in the flowchart and/or block diagram block or blocks.

The computer-readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
executing, by a data processing system, a container including a first machine learning model, training data for the first machine learning model, and a library of machine learning functions;
executing, by the data processing system, one or more of the machine learning functions of the library, wherein the one or more of the machine learning functions are configured to:
build a second machine learning model trained, at least in part, on user training data; and
compare accuracy of the first machine learning model with accuracy of the second machine learning model.

2. The method of claim 1, wherein the second machine learning model is trained on the training data of the first machine learning model and the user training data.

3. The method of claim 1, wherein the second machine learning model is trained only on the user training data.

4. The method of claim 1, wherein the container includes a plurality of different machine learning models of different types with the first machine learning model and the second machine learning model being a same type, and wherein the comparing uses at least one metric selected based on the type of the first machine learning model.

5. The method of claim 1, wherein the second machine learning model is built using incremental learning.

6. The method of claim 1, wherein the second machine learning model is built using full machine learning.

7. The method of claim 1, wherein the user training data comprises features extracted from user circuit designs.

8. The method of claim 1, wherein the training data comprises hardware features.

9. The method of claim 8, wherein the training data comprises runtime features.

10. A system, comprising:
one or more hardware processors configured to execute operations including:
executing a container including a first machine learning model, training data for the first machine learning model, and a library of machine learning functions;
executing one or more of the machine learning functions of the library, wherein the one or more of the machine learning functions are configured to:
build a second machine learning model trained, at least in part, on user training data; and
compare accuracy of the first machine learning model with accuracy of the second machine learning model.

11. The system of claim 10, wherein the second machine learning model is trained on the training data of the first machine learning model and the user training data.

12. The system of claim 10, wherein the second machine learning model is trained only on the user training data.

13. The system of claim 10, wherein the container includes a plurality of different machine learning models of different types with the first machine learning model and the second machine learning model being a same type, and wherein the comparing uses at least one metric selected based on the type of the first machine learning model.

14. The system of claim 10, wherein the second machine learning model is built using incremental learning.

15. The system of claim 10, wherein the second machine learning model is built using full machine learning.

16. The system of claim 10, wherein the user training data comprises features extracted from user circuit designs.

17. The system of claim 17, wherein the training data comprises runtime features.

18. A method, comprising:
generating training data by,
extracting, using a data processing system, circuit design features from a plurality of circuit designs;
extracting features of the data processing system, wherein the data processing system is used to perform an implementation flow on one or more of the plurality of circuit designs; and
extracting runtime features from the data processing system while the data processing system performs the implementation flow; and
training the machine learning model to predict a compilation time for circuit designs based on the training data.

19. The method of claim 18, wherein the machine learning model is a multi-component ML model.

20. The method of claim 18, wherein the runtime features are extracted by sampling runtime attributes of the data processing system during the implementation flow, and wherein the runtime features change over time as sampled.
